(19) United States
(12) Patent Application Publication
(10) Pub. No.: US 2004/0243476 A1
(43) Pub. Date: Dec. 2, 2004

(54) Method and system for hosting electronic stores using hosting contracts

(75) Inventors: Howard Borenstein, Downsview (CA); Victor S. Chan, Thomhill (CA); Lev Mirlas, Thomhill (CA); Glen Shortliffe, Markham (CA)

Correspondence Address: John D. Flynn, IBM Corporation, Dept. T81/Bldg. 503,, PO Box 12195, Research Triangle Park, NC, 27709, US

(73) Assignee: International Business Machines Corporation, Armonk, NY

(21) Appl. No.: 10/741,016

(22) Filed: Dec. 19, 2003

(30) Foreign Application Priority Data
Jun. 2, 2003 (CA) 2,430,733

(51) Int. Cl. G06F 17/60

(52) U.S. Cl. 705/26; 705/27

(57) ABSTRACT

A method for hosting an electronic store in an electronic commerce system, including deploying a hosting contract to create the electronic store; the hosting contract specifying terms and conditions for the electronic store; and, the hosting contract having a selectable contract state.

### CROSS REFERENCE TO RELATED APPLICATIONS

This application claims priority under 35 U.S.C. § 119 based upon an application filed in Canada (CA) on Jun. 2, 2003 having a Canadian application number 2,430,733 entitled A METHOD AND SYSTEM FOR HOSTING ELECTRONIC STORES USING HOSTING CONTRACTS, which is incorporated herein by reference.

### TECHNICAL FIELD

This invention relates generally to electronic commerce, and more particularly to the hosting of on-line electronic stores using hosting contracts.

### BACKGROUND INFORMATION

Few technologies have revolutionized business more than the advent of the Internet. Many merchants worldwide have been quick to realize that the Internet's true value is not in people's ability to browse the World Wide Web (“Web”) or send e-mail, but rather, in the new opportunities it creates for enhancing business processes, reducing costs and increasing profits through electronic commerce (“e-commerce”). Thus, e-commerce not only includes on-line transactions, it also encompasses technology to redefine old business models in order to maximize customer value. Not only are merchants adjusting their business processes to align with new technologies, they are fundamentally changing their organizations to be completely customer service and customer-satisfaction focused. Customers can order products or services on-line, check availability of the products, and follow their orders through the entire production process.

E-commerce systems currently exist that allow a merchant to establish an “electronic store” for selling products to customers over a computer network such as the Internet.

Now, e-commerce is traditionally carried out over a network such as the Internet using an e-commerce server networked with purchasers and merchants. The e-commerce server provides substantially all of the functionality needed to establish the electronic store and carry out buying and selling over the Internet. This includes storing product catalog information provided by merchants, accepting requests for information from prospective purchasers, and accepting and processing orders. The electronic store typically includes a collection of Web pages which describe merchants' product offerings and which include on-line forms allowing customers to place orders. Customers use Web browsers installed on their computing devices, such as personal computers, laptops, personal digital assistants (“PDAs”), cellular telephones and the like, to access the Web pages of these electronic stores to examine information about available products and to submit product orders.

The e-commerce server may be operated by a merchant or a service provider. For example, rather than operate their own e-commerce servers, smaller merchants typically purchase e-commerce services provided by a service provider (or host). In this case, the service provider owns and maintains the e-commerce server and distributes configuration, operation, and maintenance costs across the subscriber merchants to realize economies of scale. However, in so doing, the service provider usually enforces uniform standards for appearance and methods of doing business to reduce the amount of custom programming necessary in order to economically accommodate several different merchants.

Upon deciding on a product catalog selection for presentation to customers via the merchant's electronic store, the merchant and service provider will generally desire an agreement or contract specifying each party's roles and responsibilities with respect to their business relationship. For example, the service provider may be a manufacturer of the products in the product catalog and the merchant may be a reseller of the manufacturer's products. To assist resellers with their marketing, the manufacturer may provide its resellers with an electronic store hosting service. The manufacturer's Web site may, for example, include links to reseller Web pages through which customers may purchase products. In this example, the resellers benefit by having the manufacturer maintain all the common product information while receiving customer referrals from the manufacturer's Web site. The manufacturer benefits by increasing the number of channels through which its products may reach customers. As mentioned, the roles and responsibilities of the manufacturer and reseller will generally be detailed in a commercial contract or agreement.

The commercial contract may be viewed as a means for developing an ongoing business relationship between trading parties such as manufacturers and resellers. It expresses the agreement between the parties for the execution of specified activities. In addition, the contract serves as a reference for the parties with respect to the execution of the specified activities and as legal evidence of the parties' intentions regarding those activities. With respect to business relationships, the relationship between manufacturers and resellers may be referred to as business-to-business (“B2B”) while the relationship between a reseller and a customer may be referred to as business-to-consumer (“B2C”). B2C relations tend to involve single impulse transactions, supported either by implied contractual terms or by involved contract documentation setting out terms that have been essentially fixed by the reseller. On the other hand, B2B relations tend to involve ongoing partnerships, with repeated transactions that may be of a varying character. B2B commerce thus requires greater flexibility in the generation and execution of the contract governing the parties' relationship. This is especially so for manufacturers and resellers using electronic stores.

Common to all B2B trading is a contract negotiation and preparation cycle in which the parties first negotiate the terms of their contract, accept a prepared contract, and then perform the specified activities in accordance with the contract. These activities are governed by the legally binding terms and conditions included in the contract. E-commerce is, of course, governed by contracts between service providers (e.g. manufacturers), merchants (e.g. resellers), and customers. These terms and conditions may be simple or elaborate in scope. Prices and discounts are typical examples of terms and conditions, since they reflect what the reseller will pay and what the manufacturer will receive when activities are executed under the contract.

Returning to the above example of a manufacturer providing Web site hosting for a number of reseller merchants, a reseller's electronic store will generally be established by the manufacturer in accordance with the commercial contract between the manufacturer and reseller. Generally, a reseller may submit a request to have the manufacturer establish a hosted store. After negotiations, the manufacturer will approve the request and create the store in accordance with the agreed-upon contract. The existence of the store will then be subject to the set of terms and conditions in the contract defining both the content and operation of the store. For example, the manufacturer may wish to limit the selection of products from its product catalog that the reseller may offer to customers in the store. Or, the manufacturer may wish to restrict the payment options or shipping methods that the reseller may use for the store.

Thus, one problem that the hosting manufacturer faces lies in the maintenance of the varied contracts that it may have with its resellers and the corresponding transformation of these contracts into unique reseller stores. To address this problem, contracts are normally created using standard templates and attachments or by modifying an existing contract from a previous similar arrangement. The hosting manufacturer will typically have the objective of reducing the contract preparation and negotiation cycles, however even with today's communication advances, this process may still take considerable time and can lead to business losses if deadlines are missed. This exposure is more dramatic in the e-commerce B2B market where a wasted day can translate into substantial lost revenues.

Another problem faced by the hosting manufacturer is how to integrate the contractual terms and conditions into an overall e-commerce solution. In most traditional solutions, an administrator feeds one or more back-end template applications with parameters manually extracted from a printed copy of the signed contract. This can work effectively if the manufacturer's marketing and sales divisions follow a rigid set of rules during the contract negotiation cycle, but in most cases this does not happen and the hosting manufacturer ends up with a contract that does not fit precisely within the predefined back-end system parameters. In other words, the contract, or at least some terms and conditions in the contract, must be executed and controlled manually. This can present significant administrative problems for a hosting manufacturer executing activities under hundreds of contracts with resellers each requiring unique Web sites.

The cost of maintaining an electronic store is thus affected by the tools used to generate and update the Web pages comprising the store in accordance with the contract defining the relationship between the hosting manufacturer and reseller.

Existing Web page development tools are often not well suited to the task of developing and managing the content and operation of these stores as they often lack the required functionality and flexibility. These tools are often burdensome or require a high level of technical knowledge or both. As mentioned above, existing methods of establishing electronic stores use template Web pages to automate the process. However, this solution is often inadequate as the relationship between manufacturers and resellers may fluctuate requiring frequent updating to the hosted Web pages. For example, the manufacturer's product catalog may change, the reseller's marketing strategy by alter, delivery terms and conditions may vary, etc.

A need therefore exists for a method of hosting Web sites in accordance with predetermined contracts that is both flexible and efficient. Accordingly, a solution that addresses, at least in part, the above and other problems is desired.

### SUMMARY OF THE INVENTION

According to one aspect of the invention there is provided a method for hosting an electronic store in an electronic commerce system. The method includes deploying a hosting contract to create the electronic store; the hosting contract specifying terms and conditions for the electronic store; and, the hosting contract having a selectable contract state.

Desirably, the method further includes altering accessibility to the electronic store by customers by switching the selectable contract state.

Desirably, the method further includes importing the hosting contract into the electronic commerce system.

Desirably, the method further includes editing selected ones of the terms and conditions to produce edited terms and conditions.

Desirably, the method further includes: determining whether the edited terms and conditions do not comply with the hosting contract; and, in response to the determining, altering accessibility to the electronic store by switching the selectable contract state.

Desirably, the hosting contract is an XML document and the terms and conditions include at least one profile store and path information defining a sequential relationship between the electronic store and the profile stores for retrieving commerce asset information for the electronic store. And, preferably, the commerce asset information includes catalog, presentation, marketing, business logic, business policies, inventory item, inventory tracking, price, and tax calculation information.

In accordance with further aspects of the present invention there is provided an apparatus such as an e-commerce server system and a database management system, a method for adapting a database management system, as well as articles of manufacture such as a computer readable medium having program instructions recorded thereon for practising the method of the invention.

Advantageously, the present invention allows for improvements in the efficiency and flexibility of creating and hosting electronic stores by using XML based contract documents to generate stores and to specify shared commerce asset information for the generated stores.

### BRIEF DESCRIPTION OF THE DRAWINGS

Further features and advantages of the embodiments of the present invention will become apparent from the following detailed description, taken in combination with the appended drawings, in which:

FIG. 1 is a block diagram illustrating an exemplary electronic commerce system in accordance with an embodiment of the invention; and,

FIG. 2 is a flow chart illustrating operations of modules within the electronic commerce server for hosting an electronic store with a hosting contract in accordance with an embodiment of the invention.

It will be noted that throughout the appended drawings, like features are identified by like reference numerals.

### DETAILED DESCRIPTION

The following detailed description of the embodiments of the present invention does not limit the implementation of the invention to any particular computer programming language. The present invention may be implemented in any computer programming language provided that the operating system (“OS”) provides the facilities that may support the requirements of the present invention. A preferred embodiment is implemented in the JAVA™ computer programming language (or other computer programming languages such as C or C++ in conjunction with JAVA™).(JAVA and all JAVA-based trademarks are the trademarks of Sun Microsystems Corporation.) Any limitations presented would be a result of a particular type of operating system or computer programming language and would not be a limitation of the present invention.

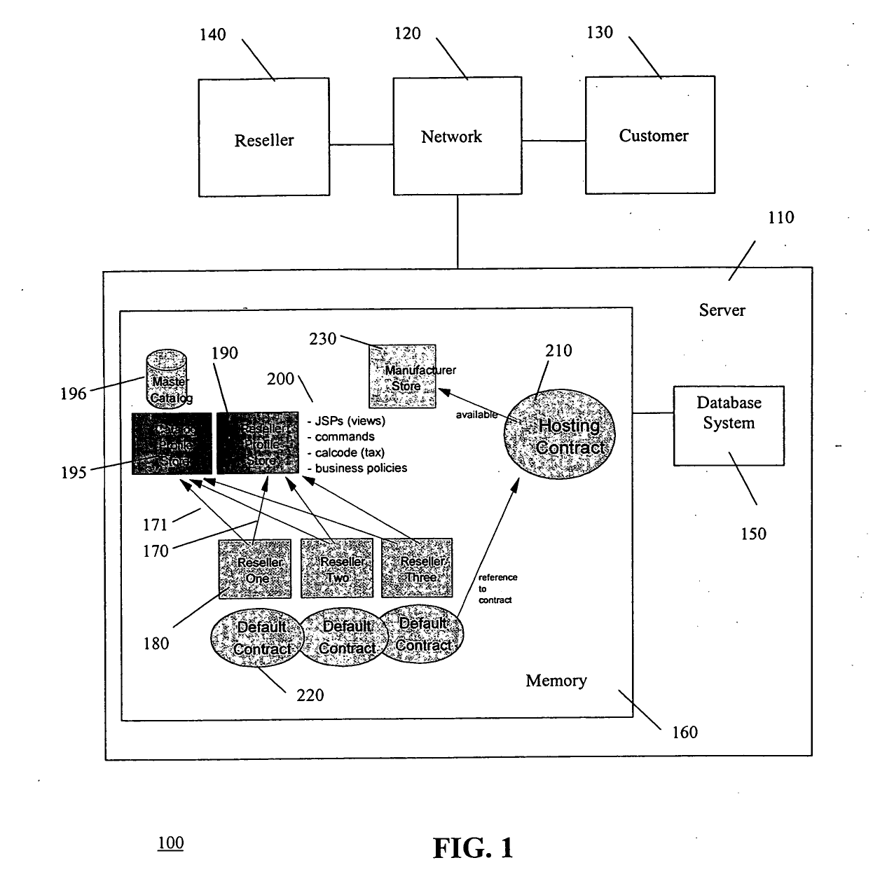

FIG. 1 is a block diagram illustrating an exemplary e-commerce system 100 in accordance with an embodiment of the invention. The e-commerce system 100 includes an e-commerce server system 110 communicating with reseller or merchant 140 and customer 130 systems over a network 120, such as the Internet. The e-commerce server system 110 which is maintained by a hosting manufacturer or other service provider includes a database system 150 for storing and accessing contract and commerce asset information (e.g. product catalog information, presentation information, etc.) for one or more resellers and provides transaction and content searching functionality. The reseller system 140 may be a server and may include the e-commerce server system 110. The server 110 is adapted to provide commerce asset information in accordance with contracts between the manufacturer and reseller and in accordance with the present invention. The customer system 130 may be a personal computer with a Web browser for accessing the commerce asset information presented by the server 110 over the network 120 as one or more Web pages.

Transaction functionality provided by the server 110 includes the capability to carry out actions needed to complete a purchase and sale over the network 120. For example, the server 110 may accept a credit card number from a customer and contact the credit card vendor to verify that the account has sufficient credit to complete the purchase of a product having a given price. Once authorization is received, the server 110 may send messages to a banking institution that debits the customer's account and credits that of the reseller or manufacturer, completing the purchase. Other transaction functionality may include: arranging to have the selected product shipped; and/or other order fulfillment functions, such as implementing a customer satisfaction survey along with product delivery, and storing the results for presentation and analysis.

The commerce asset information includes information pertaining to the format and content of the Web pages hosted by the manufacturer for resellers including products offered for sale by the reseller, product names, manufacturers, colors, sizes, and prices. It may also include multimedia information concerning the products, including text, audio, graphic, animation and video data. The server 110 also stores information concerning the contracts (i.e. “hosting” and “default” as described below) between the manufacturer, resellers, and customers including business policies, payment terms, shipping details, language, currency, warranty, guarantee, and merchandise return information, as well as background information regarding the reseller and manufacturer. In general, the commerce asset information is provided to the server 110 by the reseller and/or manufacturer who may update the information, in accordance with the applicable contracts, at any time over the network 120.

The database system 150 includes a database management system (“DBMS”) coupled to a database and is stored in the memory 160 of the server 110. It will be appreciated that the database system may be shipped or installed without the database to or by end users. In general, the DBMS is adapted to read a query generated by the server 110 in response to a customer request for commerce asset information submitted through a Web page. The DBMS then executes the query against the database and provides a query result to the server 110 for presentation to the customer. It will be appreciated that the database system may be stored in the memory of the server 110 or stored in a distributed data processing system (not shown).

An example of a suitable DBMS is the DB2™ Universal Database Management System product sold by IBM™. The DBMS is a software layer interposed between the actual database (i.e. the data as stored for use by the CPU of the server 110) and the users of the system. The DBMS is responsible for handling database transactions thus shielding users from the details of any specific computer hardware or database implementation. Using relational techniques, the DBMS stores, manipulates and retrieves data in the form of table-like relations typically defined by a set of columns or attributes of data types and a set of rows (i.e. records or tuples) of data. The standard database query language for dealing with relational databases implemented by most commercial DBMSs is the Structured Query Language (“SQL”).

The server 110 includes a central processing unit (“CPU”) (not shown) operatively coupled to memory 160 which also stores an operating system (not shown) for general management of the system 110. An example of a suitable server system 110 is an IBM™ iSeries™ computer. The server 110 includes computer executable programmed instructions for directing the server 110 to implement the embodiments of the present invention. The programmed instructions may be embodied in one or more software modules resident on the server 110. Alternatively, the programmed instructions may be embodied on a computer readable medium (such as a CD disk or floppy disk) which may be used for transporting the programmed instructions to the memory of server 110. Alternatively, the programmed instructions may be embedded in a computer-readable, signal-bearing medium that is uploaded to a network by a vendor or supplier of the programmed instructions, and this signal-bearing medium may be downloaded to the server 110 from the network by end users or potential buyers.

The CPU of the server 110 is typically coupled to one or more devices (not shown) for receiving user or customer queries and for displaying the results of the queries to users over the network 120. User queries may be transformed into a combination of SQL commands for producing one or more tables of output data which may be incorporated in one or more Web pages for presentation to the user. The CPU is coupled to memory for containing programs and data such as base tables or virtual tables such as views or derived tables. The memory may include a variety of storage devices including internal memory and external mass storage typically arranged in a hierarchy of storage as understood to those skilled in the art.

As will also be understood by those skilled in the art, the e-commerce server 110 may include a number of separate servers depending on reseller and/or manufacturer requirements. For example, the e-commerce server 110 may include separate Web presentation, Web application, transaction, data, security, and edge servers.

As mentioned above, an important concept in e-commerce applications is that of the “store”. A store represents the virtual area where business is conducted on the Web. For example, a manufacturer or reseller may establish a store on the Internet where customers may purchase or exchange goods or services. Frequently a single store is not enough to capture all of a manufacturer's or reseller's marketing strategies. For example, a manufacturer or reseller may have many brands which target different market segments.

Thus, it is frequently important to ensure that the stores on the site share the same infrastructure or commerce assets, such as presentation, business logic, catalog, fulfillment, etc. However, sometimes not all these characteristics can be shared. For example, while two stores may have many products in common, some products may only be available in one of the stores, some Web pages may also be distinct, etc., for other commerce assets.

By storing and accessing commerce assets (e.g. catalog information, presentation information, etc.) using a path infrastructure, which may be referred to as a “storepath”, the controlled sharing of selected commerce assets for a selected set of stores on a site may be facilitated. To control costs and improve efficiency, it is important that store specific and shared store assets share the same infrastructure, so that the same tools can be used to manage the shared and non-shared store assets. Advantageously, such a storepath infrastructure allows the manufacturer or reseller to decide whether a commerce asset is to be shared among stores at the time of site creation or dynamically after the site is created. This improves the flexibility of the manufacturer's or reseller's marketing strategies. If a store's storepath references another store, then the latter store may be referred to as a “profile store” for the former store.

Thus, storepaths and profile stores are created to support different types of commerce assets including: catalogs; information presentation logic; marketing information; business logic; business relationships; inventory item definitions; inventory tracking; prices; calculation methods; currency related information; unit of measure related information; and, language and locale related information.

Different stores can often be very similar in look and feel or products sold and only have small differences in presentation (e.g. store trademarks, service marks, or other store indicia) or pricing. Advantageously, profile stores allow for all the common data to be stored in one location and thus avoid having to maintain the same data in many places. This improves efficiency. The profile store can store all the common data (e.g. JAVA Server Pages™ (“JSPs”) for presentation, catalog for products sold, etc.), each store can reference the profile store, and each store can store its store specific data (e.g. store logo, prices for products sold, etc.). Thus, profile stores simplify store creation and store management functions and improve marketing flexibility.

A profile store may model specific business practices (e.g. B2C or B2B) and define one or a set of commerce assets such as catalogs, prices and business processes. A profile store can be managed using server 110 based tools but, in general, it does not support shopping activities (e.g. a customer cannot shop in a profile store). An “operational store”, that is, a store that a customer can shop in, can look up a commerce asset from one or more profile stores for a specific asset type. The storepath concept is implemented by a software module or modules within the server 110 and by storepath tables within the server's database.

Referring again to FIG. 1, storepaths 170, 171 between reseller or operational stores 180 and profile stores 190, 195 are illustrated. The concepts of storepath and profile store enable the sharing of store resources 200 such as configuration data and business processes between stores in accordance with hosting 210 and default 220 contracts. The operational store 180 draws commands, JPSs (i.e. views), calculation codes for taxes (“calcode”), and business policies from its associated profile store 190. In addition, catalog and pricelist information may be drawn from a catalog profile store 195 and a master catalog 196. Thus, the data path 170 from the operational store 180 to the profile store 190 represents a profile storepath and the data path 171 from the operational store 180 to the catalog profile store 195 represents a catalog profile storepath. To improve performance further, the storepaths may be stored in cache memory 160 within the server 110. Thus, for each store 180, a different set of storepaths can be defined for different commerce assets used by the store. Note that the manufacturer may maintain its own store 230.

As mentioned, a storepath-enabled electronic store 180 may include information relating to the following commerce assets: catalog, presentation, marketing, business logic, business policies, inventory item, inventory tracking, price, and tax calculation.

Advantageously, the present invention provides efficient and flexible operations for sharing these commerce assets among multiple stores in accordance with a hosting contract.

Now, according to the present invention, a reseller store 180 is created using a hosting contract 210 which may be an Extensible Markup Language (“XML”) document. This hosting contract embodies the agreement negotiated between a manufacturer and reseller for the manufacturer's hosting of the reseller's store 180. Each store has its own default contract 220 tailored to its particular business processes and logic. The hosting contract 210 contains all of the detailed commerce asset 200, profile store 190, 195, and storepath 170, 171 information (or references to that information) required to implement the store 180. It also contains high-level information such as store name, jurisdiction, currency, etc. The setup and creation of a store 180 is performed in the server 110 by importing and deploying this hosting contract 210. Thus, the hosting contract 210 defines the basic setup of the store 180, including business policies, payment, shipping, language and currency configuration. The hosting contract 210 also contains the terms and conditions imposed by the manufacturer describing the restrictions under which the hosted store 180 will operate and the specific business rules the hosted store must follow.

As is known, XML is a flexible way to create common information formats and share both the format and the data on the Web and other networks. XML is a formal recommendation from the World Wide Web Consortium (“W3C”) and is similar to the Hypertext Markup Language (“HTML”). An XML document can be processed purely as data by a program, it can be stored, or it can be displayed like an HTML document. Thus, XML is “extensible” because, unlike HTML, the markup symbols are unlimited and self-defining. In addition, XML markup may appear within an HTML page.

The manufacturer can include a set of terms and conditions in the hosting contract 210 to control and restrict the behaviour of the store 180. These terms and conditions may include the following:

1. Product Catalog 195 (i.e., as described above, the set of products that the store is allowed to sell. This set may include all or a subset of the manufacturer's product catalog);

2. Storepath 170, 171 (i.e., which marketing profile store to use, which catalog profile store 195 to use, etc.);

3. Price (e.g. a suggested retail price);

4. Payment method (i.e., payment methods available for the store, a subset of which may be selected).

5. Shipping method (i.e., shipping methods available for the store, a subset of which may be selected); and,

6. Various variables such as the maximum number of catalog items that can be added to the store at any given time (e.g. if a store is at its limit, it can delete some items and add new ones).

The creation of the hosting contract 210 may follow the standard contract negotiation cycle described above. That is, a reseller submits a draft version of the hosting contract 210 to the manufacturer for negotiation and approval. The manufacturer approves the draft and the contract 210 is deployed. The draft version of the hosting contract 210 may be based on a template contract. This cycle can be conducted on-line (e.g. by email) through communications between a reseller 140 and manufacturer's server 110 and store 230 over the Internet 120.

When the hosting contract 210 is deployed by the server 110, the hosted store 180 is created having a default contract 220 that refers to the hosting contract 210. Within the hosted store 180, all activities are driven by this default contract 220. Thus, while the hosting contract 210 specifies the terms and conditions of the agreement between the manufacturer and reseller, the default contract 220 specifies the terms and conditions of the agreements between the reseller and its customers. The terms and conditions in the default contract 220 can be the same (i.e. default to) as those specified in the hosting contract 210. Or, the terms and conditions of the default contract can be modified by the reseller within parameters allowed by the terms and conditions of the hosting contract 210. For example, the hosting contract 210 may specify delivery of products within the U.S.A. while the default contract 220 may specify delivery within the State of New York.

The default contract 220 references the hosting contract 210 thereby augmenting the set of terms and conditions available to the business logic of the store 180. The behaviour of the store is controlled by the terms and conditions specified by the reseller in the default contract 220 as well as by the terms and conditions agreed to by the manufacturer in the hosting contract 210. In effect, the hosting contract 210 governs the default contract 220. That is, the default contract 220 defines the reseller's terms and conditions subject to the terms and conditions in the manufacturer's hosting contract 210.

At runtime within the server 110, when the terms and conditions are retrieved for a default contract 220 for the store 180, the terms and conditions specified by the reseller in the default contract 220 are retrieved, as well as the terms and conditions specified in the hosting contract 210. Again, all default contracts 220 associated with a resellers' store or stores 180 have a reference to the hosting contract 210.

Now, once the hosting contract 210 XML document has been created, it can be imported and then deployed by the server 110. Deploying the hosting contract 210 creates the hosted store 180 and the default contract 220 for that store. If the manufacturer wants to suspend presentation of the hosted store 180 to customers 130 of the reseller 140, because, for example, the reseller 140 has breached a term or condition of the hosting contract 210, then the manufacturer can suspend the hosting contract 210. If the hosting contract 210 is suspended, only the owner of the store (i.e. the reseller) can modify the store data and enter the store 180 for testing. Once the reseller 140 has fixed the problem, the manufacturer can resume the hosting contract 210 and the store 180 will be available for presentation to customers 130 once again.

If any changes are required to the hosting contract 210, a new version can be imported, and the hosting contract 210 can be redeployed to update the modified set of terms and conditions. If the hosted store 180 is no longer required, then the hosting contract 210 is deleted from the server 110 and the store 180 is unavailable.

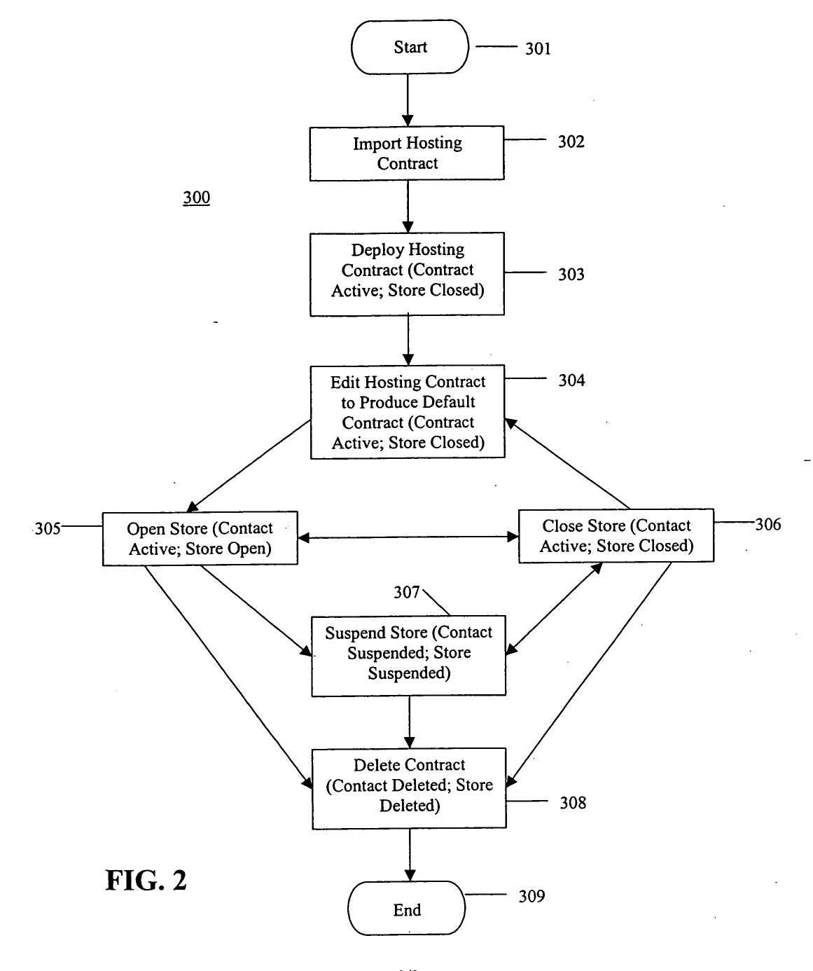

FIG. 2 is a flow chart illustrating operations 300 of modules within an electronic commerce server 110 for hosting an electronic store 180 with a hosting contract 210 in accordance with an embodiment of the invention. At step 301, the operations 300 start.

At step 302, a hosting contract 210 is imported into the electronic commerce system 100. The hosting contract 210 specifies parameters (e.g. retail price, etc.) for the hosted store 180.

At step 303, the hosting contract 210 is deployed to create the hosted store 180. 10 At this point, the hosting contract 210 is in an “active state” and the hosted store 180 is in a “closed state”. When a hosting contract 210 is in the active state, the hosted store 180 that it defines can be put in an “open state” by the reseller 140 (or manufacturer) during which customer 130 access to the store 180 is allowed, or, the hosted store 180 can be put in a “closed state” by the reseller 140 (or manufacturer) during which customer 130 access to the store 180 is prevented.

At step 304, selected parameters (e.g. retail price, etc.) are edited to produce edited parameters. Editing may be performed by the reseller or the manufacturer. The result of this editing is a default contract 220 for the store 180. At this point, the hosting contract 210 is in the active state but the hosted store 180 is in the closed state to prevent customer 130 access.

At step 305, the hosted store 180 is made accessible with the edited or original parameters for customer shopping by changing the hosted store 180 to the open state.

At step 306, the store 180 may be made inaccessible by changing the hosted store 180 to the closed state. Selected parameters for the store 180 may be edited or re-edited edited and the store 180 may be made accessible by changing its state to open 305.

At step 307, the store 180 may be made inaccessible by changing the hosting contract 210 to a “suspended state”. When the hosting contract 210 is in the suspended state, the hosted store 180 enters a “suspended state” as well and is inaccessible to customers 130. The suspended state is initiated by the manufacturer if, for example, the reseller 130 violates a term or condition of the contract 210. That is, if the edited parameters do not comply with the hosting contract 210.

The store 180 may be made accessible by returning the hosting contract 210 to the active state. This may occur, for example, after the reseller 130 has corrected any problems with the edited parameters. When the hosting contract 210 is returned to the active state, the hosted store 210 returns to the closed state from the suspended state. The reseller 130 may then open the store 180.

At step 308, the hosted store 180 may be made inaccessible by deleting the hosting contract 210. This operation deletes the hosted store 180. A new or revised hosting contract 210 may be re-imported 302.

At step 309, operations 300 end.

Thus, the hosted store 180 can be in one of the following three states:

1. Opened. The store 180 is ready and available to customers 130;

2. Closed. The store owner (i.e. the reseller 140) can make modifications to the store 180. When the store 180 is ready, the store owner can open the store 180 and make it available to customers 130; and,

3. Suspended. The store owner can make modifications to the store 180.

However, to make the store 180 available to customers 130, the store owner must contact the manufacturer's administrator so that the administrator can “resume” the availability of the store 180 (i.e. change the hosting contract 210 from the suspended to active states). If the reseller 140 is to pay for the hosted store 180, the manufacturer's administrator would not resume the hosting contract 210 until payment has been received.

Further, if the reseller 140 wants to temporarily make the store 180 unavailable to its customers 130 so that the reseller 140 can make changes to the store 180, then the reseller 140 can:

1. Close 306 the store 180 and make the changes 304; and,

2. Open 305 the store 180 when the changes 304 are completed.

In addition, if the manufacturer believes that the reseller 140 has breached a term or condition of the hosting contract 210 with the operation of its store 180, then the manufacturer can:

1. Suspend 307 the hosting contract 210. The reseller 140 can make any necessary changes to the store 180; and,

2. Once the necessary changes have been made, then the manufacturer's administrator can resume 306 the hosting contract 210 (i.e. change the hosting contract 210 from the suspended state to the active state).

Moreover, if the manufacturer wants to change the terms and conditions for the hosted store 180, then the manufacturer can:

1. Create a new version of the hosting contract 210 including the modified terms and conditions;

2. Import 302 and deploy 303 the new version of the hosting contract 210 in the server 110; and,

3. Close the old version of the hosting contract 210 and activate the new version. Any default store contract 220 that referenced the old version of the hosting contract 210 will now reference the new version of the hosting contract 210.

Finally, if the manufacturer wants to end the hosting of the reseller's store 180, then the manufacturer can: Delete 308 the hosting contract 210. The hosted store 180 will be deleted and inaccessible to the reseller 140 and its customers 130.

While this invention is primarily discussed as a method, a person of ordinary skill in the art understands that the apparatus discussed above with reference to a computer-implemented e-commerce server and system may be programmed or configured to enable the practice of the method of the invention. Moreover, an article of manufacture for use with a data processing system, such as a pre-recorded storage device or other similar computer readable medium including program instructions recorded thereon may direct the data processing system to facilitate the practice of the method of the invention. It is understood that such apparatus and articles of manufacture also come within the scope of the invention.

The embodiment(s) of the invention described above is(are) intended to be exemplary only. The scope of the invention is therefore intended to be limited solely by the scope of the appended claims.

We claim:

1. A method for hosting an electronic commerce system comprising the steps of:
executing a hosting contract between a service provider and a reseller, the hosting contract specifying terms and conditions of the relationship between the service provider and the reseller;
deploying the hosting contract to create an electronic hosting store accessible by customers through a network;
creating a default contract between the customer and the reseller through the electronic hosting store;
determining if the default contract complies with the hosting contract terms and conditions;
choosing a selectable contract state upon determination of compliance between the default contract with the hosting contract terms and conditions; and
permitting editing of the terms and conditions to facilitate changing the contract state.

2. The method of claim 1 wherein the hosting contract is an XML document.

3. The method of claim 1 wherein the terms and conditions of the hosting contract include at least one profile store, the profile store including commerce asset information for the electronic store and path information defining a sequential relationship between the electronic store and the at least one profile store for retrieving the commerce asset information.

4. The method of claim 3 wherein the commerce asset information includes inventory items.

5. The method of claim 3 wherein the commerce asset information includes inventory items and inventory item pricing.

6. The method of claim 3 wherein the commerce asset information includes marketing information.

7. The method of claim 3 wherein the commerce asset information includes tax collection information.

8. The method of claim 3 wherein the commerce asset information includes the service provide catalogue, business logic, business policies, inventory items, inventory pricing, inventory tracking, and tax calculation information for sales.

9. The method of claim 3 wherein the hosting contract is an XML document.

10. The method of claim 4 wherein the hosting contract is an XML document.

11. The method of claim 5 wherein the hosting contract is an XML document.

12. The method of claim 6 wherein the hosting contract is an XML document.

13. The method of claim 7 wherein the hosting contract is an XML document.

14. A method for hosting an electronic commerce system comprising the steps of:
executing a hosting contract between a service provider and a reseller, the hosting contract specifying terms and conditions of the relationship between the service provider and the reseller, the terms and conditions of the hosting contract including at least one profile store, the profile store including commerce asset information for the electronic store and path information defining a sequential relationship between the electronic store and the at least one profile store for retrieving the commerce asset information, wherein the commerce asset information includes inventory items;
deploying the hosting contract to create an electronic hosting store accessible by customers through a network;
creating a default contract between the customer and the reseller through the electronic hosting store;
determining if the default contract complies with the hosting contract terms and conditions;
choosing a selectable contract state upon determination of compliance between the default contract and with the hosting contract terms and conditions; and
permitting editing of the terms and conditions to facilitate changing the contract state.

15. The method of claim 14 the hosting contract is an XML document.

16. The method of claim 14 wherein the commerce asset information includes inventory pricing.

17. The method of claim 14 wherein the commerce asset information includes marketing information.

18. The method of claim 14 wherein the electronic store is hosted by the service provider.

19. An electronic commerce system for providing a product to a customer from a service provider through a reseller, the system comprising;
a hosting contract between a service provider and a reseller, the hosting contract having terms and conditions including at least one profile store, the profile store including commerce asset information for an electronic store and path information defining a sequential relationship between the electronic store and the at least one profile store for retrieving the commerce asset information, wherein the commerce asset information includes inventory information and inventory item pricing;
an electronic store provided by the service provider that is selectively accessible by the service provider, the reseller, and a customer, the electronic store being created pursuant to the terms and conditions of the hosting contract;
a default contract between the reseller and the customer provided through the electronic store;
means for comparing the default contract with the hosting contract to determine if the default contract complies with the terms and conditions of the hosting contract;
means for selecting a contract state upon determination of compliance between the default contract and the host contract; and
means for editing the terms and conditions to change the selected contract state.

20. The system of claim 19 wherein the hosting contract is an XML document.
